(19) United States
(12) Patent Application Publication
(10) Pub. No.: US 2014/0364528 A1
(43) Pub. Date: Dec. 11, 2014

(54) POLYOL FORMULATIONS FOR IMPROVED COLD TEMPERATURE SKIN CURE OF POLYURETHANE RIGID FOAMS

(71) Applicants: Eric M. Rexrode, Missouri City, TX (US); David E. Snider, Jasper, GA (US); Woo-Sung Bae, Midland, MI (US); Mikhail Y. Gelfer, Sugarland, TX (US); Jorge Jimenez, Lake Jackson, TX (US)

(72) Inventors: Eric M. Rexrode, Missouri City, TX (US); David E. Snider, Jasper, GA (US); Woo-Sung Bae, Midland, MI (US); Mikhail Y. Gelfer, Sugarland, TX (US); Jorge Jimenez, Lake Jackson, TX (US)

(73) Assignee: DOW GLOBAL TECHNOLOGIES LLC, Midland, MI (US)

(21) Appl. No.: 13/880,898

(22) PCT Filed: Dec. 13, 2011
(86) PCT No.: PCT/US11/64628

§ 371 Date: Apr. 22, 2013

Related U.S. Application Data
(60) Provisional application No. 61/425,351, filed on Dec. 21, 2010.

(51) Int. Cl. C08G 18/48; C08G 18/76; C08G 18/08; C08G 63/668

(52) U.S. Cl. CPC C08G 18/4887; C08G 63/668; C08G 18/7671; C08G 18/14; C08G 2101/0025
USPC 521/177; 528/301; 525/437

(57) ABSTRACT

A polyol formulation comprising certain type of polyester polyols useful in the preparation of rigid polyurethane foams having low surface friability is provided. In one embodiment, a reaction system for production of a rigid foam is provided. The reaction system comprises a polyester polyol and one or more polyisocyanates, wherein the polyester polyol and the polyisocyanates are mixed in amounts sufficient to provide a rigid polyurethane foam. The polyester polyol comprises the reaction product of from 20 to 60 weight percent of an aromatic component comprising at least 80 mole percent or greater of terephthalic acid, from 20 to 60 weight percent of a polyethylene glycol having a number average molecular weight from 150 to 1,000, from 5 to 20 weight percent of a glycol having a functionality of 2 and molecular weight of 60 to 250 and from 5 to 20 weight percent of a glycol having a functionality of at least 3 and a molecular weight of 60 to 250.

### BACKGROUND OF THE INVENTION

1. Field of the Invention

The present invention relates to a polyol formulation comprising certain polyester polyols useful in the preparation of polyurethane rigid foams. Such foams are particularly useful in producing composite elements, such as sandwich panels.

2. Description of the Related Art

Polyurethane foams are used in a wide variety of applications, ranging from cushioning (such as mattresses, pillows and seat cushions) to packaging to thermal insulation and for medical applications. Polyurethanes have the ability to be tailored to particular applications through the selection of the raw materials that are used to form the polymer. Rigid types of polyurethane foams are used as appliance insulation foams and other thermal insulating applications.

The use of a polyol in preparation of polyurethanes by reaction of the polyol with a polyisocyanate in the presence of a catalyst and perhaps other ingredients is well known. Aromatic polyester polyols, such as those based on dimethyl terephthalate (DMT) bottoms, are widely used in the manufacture of flame rated rigid polyurethane panels to aid in flammability performance of the foams. Typical formulations using these aromatic polyester polyols show a tendency toward high surface friability which requires relatively high mold or “skin cure” temperatures to avoid production defects such as blistering of the panel skins. Such high skin cure temperatures lead to increased processing times while in some cases leading to a decrease in quality of the final product. Attempts to modify the polyurethane formulation to reduce the surface friability have resulted in other negative consequences in terms of the processing and/or properties of the foam.

It would be desirable to reduce surface friability and improve skin cure of such rigid polyurethane foam systems at a mold temperature near ambient temperature while reducing the tendency of the rigid foam to blister without negatively affecting foam processing or the material properties of the foam product.

### SUMMARY OF THE INVENTION

The present invention relates to a polyol formulation for making polyurethane rigid foams having reduced surface friability and improved skin cure at a given mold temperature for use as insulation in construction applications. One embodiment of the invention provides a polyol blend comprising a polyether polyol having a functionality of 2 to 8 and a molecular weight of 100 to 2,000, and from 20 to 90 weight percent of an aromatic polyester polyol comprising the reaction product of at least:

A) an aromatic component comprising 80 mole percent or greater of terephthalic acid;

B) at least one polyether polyol having a nominal functionality of 2, a molecular weight of 150 to 1000 and has a polyoxyethylene content of at least 70% by weight of the polyol; and

C) at least one glycol other than B having a molecular weight from 60 to 250;

D) at least one glycol having a molecular weight of 60 to 250 and a nominal functional of at least 3;

wherein A, B, C and D are present in the reaction on a percent weight bases of 20 to 60 weight percent A); 20 to 60 weight percent of B) and 5 to 20 weight percent of C) and 5 to 20 weight percent of D).

In a further aspect, the present invention provides a reaction system for production of a rigid foam comprising the reaction product of:
(1) a polyol blend as described above,
(2) a polyisocyanate, and
(3) optionally additives and auxiliaries known per se. Such optional additives or auxiliaries are selected from the groups consisting of dyes, pigments, internal mold release agents, physical blowing agents, chemical blowing agents, fire retardants, fillers, reinforcements, plasticizers, smoke supresants, fragrances, antistatic agents, biocides, antioxidants, light stabilizers, adhesion promotors and combination of these.

In another aspect the invention provides a process for preparing a rigid polyurethane foam, comprising:
a) forming a reactive mixture contains at least
   1) a polyol blend as described above
   2) a polyisocyanate,
   3) at least one hydrocarbon, hydrofluorocarbon, hydrochlorofluorocarbon, fluorocarbon, dialkyl ether or fluorine-substituted dialkyl ether physical blowing agent;
b) subjecting the reactive mixture to conditions such that the reactive mixture expands and cures to form a rigid polyurethane foam.

In another aspect the invention provides a composite element comprising:

i) a lower facing,

ii) a rigid foam product comprising the reaction product of

(1) an isocyanate and
(2) a polyol mixture wherein the polyol mixture comprises

a first polyol which is polyester polyol comprising the reaction product of:

at least
A) an aromatic component comprising 80 mole percent or greater of terephthalic acid;
B) at least one polyether polyol having a nominal functionality of 2, a molecular weight of 150 to 1000 and has a polyoxyethylene content of at least 70% by weight of the polyol; and
C) at least one glycol other than B having a molecular weight from 60 to 250;
D) at least one glycol having a molecular weight of 60 to 250 and a nominal functional of at least 3;
wherein A, B, C and D are present in the reaction on a percent weight bases of 20 to 60 weight percent A); 20 to 60 weight percent of B) and 5 to 20 weight percent of C) and 5 to 20 weight percent of D).

and

a second polyol which is a polyether polyol having a functionality of 2 to 8 and a molecular weight of 100 to 2,000; wherein the first to second polyol are present in a weight percent of the polyol mixture from 20 to 90 eight percent of the first polyol and 10 to 80 weight percent of the second polyol, and

iii) an upper facing.

In another embodiment the invention provides a process for preparing a composite element according wherein the rigid foam (ii) adheres to (i) and (iii) and is prepared between (i) and (iii) by reacting the isocyanate and polyol mixture at a temperature of 25° C. to 50° C. In a further embodiment, temperature of a mold in which the foaming takes place is less than 35° C.

### DETAILED DESCRIPTION

The polyol blend of the present invention comprises high functionality polyether polyols and certain aromatic polyester polyols prepared from a reaction mixture comprising at least A) terephthalic acid; B) at least one polyether polyol wherein the polyether polyol has a functionality of 2 and has a polyoxyethylene content of at least 70% by weight of the polyol; and C) at least one glycol component other than B) having a molecular weight from 60 to 250 and D) at least one glycol having a molecular weight of 60 to 250 and a nominal functional of at least 3. It was found that such polyol blend can be used to produce polyurethane foams having reduced surface friability and improved skin cure at a given mold temperature while reducing the tendency of the rigid foam to blister without negatively affecting foam processing or the material properties of the foam. In particular, it was found the tendency of the foam to blister at reduced mold temperatures is decreased by the use of the disclosed polyester in producing such panels.

The aromatic component (component A) of the present polyester polyols is primarily derived from terephthalic acid. The terephthalic acid component will generally comprise 80 mole percent or more of the aromatic content. In further embodiments, terephthalic acid will comprise 85 mole percent or more of the aromatic component. In another embodiment, terephthalic acid will comprise 90 mole percent or more of the aromatic component for making the aromatic polyester polyol. In another embodiment, the aromatic content comprises greater than 95 mole percent terephthalic acid. In another embodiment, the aromatic content is essentially derived from terephthalic acid. While the polyester polyols can be prepared from substantially pure terephthalic acid, more complex ingredients can be used, such as the side-stream, waste or scrap residues from the manufacture of terephthalic acid. Recycled materials which can be broken down into terephthalic acid and diethylene glycol, such as the digestion products of polyethylene terephthalate, may be used. Other types of aromatic materials which may be present include, for example, phthalic anhydride, trimellitic anhydride, dimethyl terephthalic residues.

Component A) will generally comprise from 20 to 60 wt % of the reaction mixture. In a further embodiment, component A) comprise 30 wt % or greater of the reaction mixture. In a further embodiment, component A) comprises 35 wt % or more of the reaction mixture.

Component B) is a polyether polyol obtained by the alkoxylation of suitable starting molecules (initiators) with a C₂ to C₄ alkylene oxide, such as ethylene oxide, propylene oxide, 1,2- or 2,3-butylene oxide, tetramethylene oxide or a combination of two or more thereof. The polyether polyol will generally contain greater than 70% by weight of oxyalkylene units derived from ethylene oxide (EO) units and preferably at least 75% by weight of oxyalkylene units derived from EO. In other embodiments, the polyol will contain greater than 80 wt % of oxyalkylene units derived from EO and in a further embodiment, 85 wt % or more of the oxyalkylene units will be derived from EO. In some embodiments, ethylene oxide will be the sole alkylene oxide used in the production of the polyol. When an alkylene oxide other than EO is used, it is preferred the additional alkylene oxide, such as propylene or butylene oxide is fed as a co-feed with the EO or fed as an internal block. Catalysis for this polymerization can be either anionic or cationic, with catalysts such as potassium hydroxide, cesium hydroxide, boron trifluoride, or a double cyanide complex (DMC) catalyst such as zinc hexacyanocobaltate or quaternary phosphazenium compound. In the case of alkaline catalysts, these alkaline catalysts are preferably removed from the polyol at the end of production by a proper finishing step, such as coalescence, magnesium silicate separation or acid neutralization.

The polyethylene oxide based polyol, generally has a molecular weight of from 150 to 1,000. In one embodiment, the number average molecular weight is 160 or greater. In a further embodiment, the number average molecular weight is less than 800, or even less than 600. In a further embodiment, the number average molecular weight is less than 500.

The initiators for production of component B) have a functionality of 2. As used herein, unless otherwise stated, the functionality refers to the nominal functionality. Non-limiting examples of such initiators include, for example, ethylene glycol, diethylene glycol and propylene glycol.

The polyethylene oxide based polyol generally comprises from 20 to 60 weight percent of the reaction mixture. In a further embodiment, the polyethylene oxide based polyol will comprise from 30 to 60 wt percent of the reaction mixture. In another embodiment, the polyethylene oxide based polyol will comprise at least 35 wt % or 40 wt % of the reaction mixture.

In addition to the aromatic component A) and the polyethylene oxide based polyol component B), the reaction mixture for producing the polyester polyol contains one or more glycols having a molecular weight of 60 to 250 (component C) which is different from B). Such glycol, or blend of glycols, will generally have a nominal functionality of 2.

In one embodiment, 2 functional glycols of component C) may be represented by the formula:

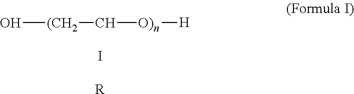

where R is hydrogen or a lower alkyl of 1 to 4 carbon atoms and n is selected to give a molecular weight of 250 or less. In further embodiments n is selected to give a molecular weight of less than 200. In a further embodiment, R is hydrogen. Non-limiting examples of diglycols which can be used in the present invention include ethylene glycol, diethylene glycol, and other polyethylene glycols, propylene glycol, dipropylene glycol, etc.

Component C) will generally comprise at least 5 weight percent of the reaction mixture and generally less than 20 weight of the reaction mixture for making the polyester. In another embodiment, the glycol component will comprise greater than 7 wt % of the reaction mixture. In a further embodiment, the glycol component will be less than 18 wt % of the reaction mixture.

Component D) is glycol having a nominal functionality of 3 or greater. Three functional glycols include, for example glycerin and trimethylolpropane. Higher functional glycols include, for example, pentaerythritol. Component D) will generally comprise at least 5 weight percent of the reaction mixture and generally less than 20 weight of the reaction mixture for making the polyester. In another embodiment, the glycol component will comprise greater than 7 wt % of the reaction mixture. In a further embodiment, the glycol component will be less than 18 wt % of the reaction mixture.

Based on the components in making the polyester, the polyester will have a nominal functionality greater than 2.3 and generally no greater than 3.1. In further embodiments the polyester will have a functionality of from 2.4 to 2.9. In a further embodiment the polyester has a functionality of 2.5 or greater. The amount of materials used in making the polyester will generally provide for a polyester having a hydroxyl number of from 200 to 400. In further embodiments the hydroxyl number of the polyester is less than 350.

By inclusion of a specified amount of polyethylene oxide based polyol along with other glycols as specified above, along with the aromatic component, the viscosity of the resulting polyester is generally less than 30,000 mPa*s at 25° C. as measured by UNI EN ISO 3219. In a further embodiment the viscosity of the polyester polyol is less than 20,000 mPa*s. While it is desirable to have a polyol with as low a viscosity as possible, due to practical chemical limitations and end-use applications, the viscosity of the polyol will generally be greater than 1,000 mPa*s.

An aromatic polyester polyol of the invention may include any minor amounts of unreacted glycol remaining after the preparation of the polyester polyol. Although not desired, the aromatic polyester polyol can include up to about 30 weight percent free glycol/polyols. The free glycol content of the aromatic polyester polyols of the invention generally is from about 0 to about 30 weight percent, and usually from 1 to about 25 weight percent, based on the total weight of polyester polyol component. The polyester polyol may also include small amounts of residual, non-inter-esterified aromatic component. Typically the non-inter-esterified aromatic materials will be present in an amount less than 2 percent by weight based on the total weight of the components combined to form the aromatic polyester polyols of the invention.

The polyester polyols may be formed by the polycondensation/transesterification and polymerization of components A, B, and C under conditions well known in the art. See for Example G. Oertel, Polyurethane Handbook, Carl Hanser Verlag, Munich, Germany 1985, pp 54-62 and Mihail Ionescu, Chemistry and Technology of Polyols for Polyurethanes, Rapra Technology, 2005, pp 263-294. In general, the synthesis is done at temperature of 180 to 280° C. In another embodiment the synthesis is done at a temperature of at least 200° C. In a further embodiment the synthesis is done at a temperature of 215° C. or greater. In a further embodiment the synthesis is done at a temperature of 260° C. or less.

While the synthesis may take place under reduced or increased pressure, the reaction is generally carried out near atmospheric pressure conditions.

While the synthesis may take place in the absence of a catalyst, catalysts which promote the esterification/transesterification/polymerization reaction may be used. Examples of such catalysts include tetrabutyltitanate, dibutyl tin oxide, potassium methoxide, or oxides of zinc, lead or antimony; titanium compounds such as titanium (IV) isopropoxide and titanium acetylacetonate. When used, such catalyst is used in an amount of 0.005 to 1 weight percent of the total mixture. In further embodiments the catalyst is present in an amount of from 0.005 to 0.5 weight percent of the total mixture.

The volatile product(s) of the reaction, for example water and/or methanol, is generally taken off overhead in the process and forces the ester interchange reaction to completion.

The synthesis usually takes from one to five hours. The actual length of time required varies, of course; with catalyst concentration, temperature etc. In general, it is desired not to have too long a polymerization cycle, both for economic reasons and for the reason that if the polymerization cycle is too long, thermal degradation may occur.

The polyester polyols described herein are used as part of a polyol formulation for making various polyurethane or polyisocyanurate products. The polyol, also referred to as the isocyanate-reactive component, along with an isocyanate component make-up a system for producing a polyurethane or polyisocyanurate foam. Depending on the application, the polyester will generally range from 20 to 90 wt % of the total polyol formulation. The amount of polyester polyols which can be used for particular applications can be readily determined by those skilled in the art.

Other representative polyols in the formulation include polyether polyols, polyester polyols different from the polyester of the present invention, polyhydroxy-terminated acetal resins, and hydroxyl-terminated amines. Alternative polyols that may be used include polyalkylene carbonate-based polyols and polyphosphate-based polyols. Preferred are polyether or polyester polyols. Polyether polyols prepared by adding an alkylene oxide, such as ethylene oxide, propylene oxide, butylene oxide or a combination thereof, to an initiator having from 2 to 8 active hydrogen atoms. The functionality of polyol(s) used in a formulation will depend on the end use application as known to those skilled in the art. Such polyols advantageously have a functionality of at least 2, preferably 3, and up to 8, preferably up to 6, active hydrogen atoms per molecule. The polyols used for rigid foams generally have a hydroxyl number of about 200 to about 1,200 and more preferably from about 250 to about 800.

Polyols that are derived from renewable resources such as vegetable oils or animal fats may also be used as additional polyols. Examples of such polyols include castor oil, hydroxymethylated polyesters as described in WO 04/096882 and WO 04/096883, hydroxymethylated polyols as described in U.S. Pat. Nos. 4,423,162; 4,496,487 and 4,543,369 and “blown” vegetable oils as described in US Published Patent Applications 2002/0121328, 2002/0119321 and 2002/0090488.

To increase cross-linking network the polyol blend may contain a higher functional polyol having a functionality of 5 to 8. Initiators for such polyols include, for example, pentaerythritol, sorbitol, sucrose, glucose, fructose or other sugars, and the like. Such higher functional polyols will have an average hydroxyl number from about 200 to about 850, preferably from about 300 to about 770. Other initiators may be added to the higher functional polyols, such a glycerin to give co-initiated polyols functionality of from 4.1 to 7 hydroxyl groups per molecule and a hydroxyl equivalent weight of 100 to 175. When used, such polyols will generally comprise from 30 to 70 wt % of the polyol formulation for making a rigid foam, depending on the particular application.

The polyol mixture may contain up to 20% by weight of still another polyol, which is not the polyester, an amine-initiated polyol or a higher functional polyol and which has a hydroxyl functionality of 2.0 to 3.0 and a hydroxyl equivalent weight of from 90 to 600.

For construction applications, the polyol blend may also include a polyol formed alkoxylation product of a phenol-formaldehyde resin. Such polyols are known in the art as Novolac polyols. When used in a formulation, they can be present in an amount of up 20 wt percent.

In one embodiment, the invention provides a polyol blend comprising from 30 to 80 weight percent of an aromatic polyester polyol as described above and the remainder is at least one polyol or a combination of polyols having a functionality of 2 to 8 and molecular weight of 100 to 10,000.

Specific examples of polyol mixtures suitable for producing a rigid foam for construction applications having improved skin cure include a mixture of from 30 to 80% by weight of the polyester of the present invention; from 20 to 70% by weight of sorbitol or sucrose/glycerin initiated polyether polyol wherein the polyol or polyol blend has a functionality of 3 to 8 and a hydroxyl equivalent weight of 200 to 850, and up to 20% by weight of another polyols having a hydroxyl functionality of 2.0 to 3.0 and a hydroxyl equivalent weight of from 90 to 500.

Polyol mixtures as described can be prepared by making the constituent polyols individually, and then blending them together. Alternatively, polyol mixtures, not including the polyester, can be prepared by forming a mixture of the respective initiator compounds, and then alkoxylating the initiator mixture to form the polyol mixture directly. Combinations of these approaches can also be used.

Suitable polyisocyanates for producing polyurethane products include aromatic, cycloaliphatic and aliphatic isocyanates. Such isocyanates are well known in the art.

Examples of suitable aromatic isocyanates include the 4,4′-, 2,4′ and 2,2′-isomers of diphenylmethane diisocyante (MDI), blends thereof and polymeric and monomeric MDI blends, toluene-2,4- and 2,6-diisocyante (TDI) m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. In one embodiment, TDI/MDI blends are used.

Examples of aliphatic polyisocyanates include ethylene diisocyanate, 1,6-hexamethylene diisocyanate, 1,3- and/or 1,4-bis(isocyanatomethyl)cyclohexane (including cis- or trans-isomers of either), isophorone diisocyanate (IPDI), tetramethylene-1,4-diisocyanate, methylene bis(cyclohexaneisocyanate) (H₁₂MDI), cyclohexane 1,4-diisocyanate, 4,4′-dicyclohexylmethane diisocyanate, saturated analogues of the above mentioned aromatic isocyanates and mixtures thereof.

Derivatives of any of the foregoing polyisocyanate groups that contain biuret, urea, carbodiimide, allophonate and/or isocyanurate groups can also be used. These derivatives often have increased isocyanate functionalities and are desirably used when a more highly crosslinked product is desired.

For production of rigid polyurethane or polyisocyanruate materials, the polyisocyanate is generally a diphenylmethane-4,4′-diisocyanate, diphenylmethane-2,4′-diisocyanate, polymers or derivatives thereof or a mixture thereof. In one preferred embodiment, the isocyanate-terminated prepolymers are prepared with 4,4′-MDI, or other MDI blends containing a substantial portion or the 4.4′-isomer or MDI modified as described above. Preferably the MDI contains 45 to 95 percent by weight of the 4,4′-isomer.

The polyisocyanate is used in an amount sufficient to provide an isocyanate index of from 80 to 200. Isocyanate index is calculated as the number of reactive isocyanate groups provided by the polyisocyanate component divided by the number of isocyanate-reactive groups in the polyurethane-forming composition (including those contained by isocyanate-reactive blowing agents such as water) and multiplying by 100. Water is considered to have two isocyanate-reactive groups per molecule for purposes of calculating isocyanate index. For rigid polyurethane foam applications, the preferred isocyanate index is generally from 100 to 150.

It is also possible to use one or more chain extenders in the formulation for production of polyurethane products. The presence of a chain extending agent provides for desirable physical properties, of the resulting polymer. The chain extenders may be blended with the polyol component or may be present as a separate stream during the formation of the polyurethane polymer. A chain extender is a material having two isocyanate-reactive groups per molecule and an equivalent weight per isocyanate-reactive group of less than 400, preferably less than 300 and especially from 31-125 daltons. Crosslinkers may also be included in formulations for the production of polyurethane polymers of the present invention. “Cosslinkers” are materials having three or more isocyanate-reactive groups per molecule and an equivalent weight per isocyanate-reactive group of less than 400. Crosslinkers preferably contain from 3-8, especially from 3-4 hydroxyl, primary amine or secondary amine groups per molecule and have an equivalent weight of from 30 to about 200, especially from 50-125.

The polyol blend of the present invention may be utilized with a wide variety of blowing agents. The blowing agent used in the polyurethane-forming composition includes at least one physical blowing agent which is a hydrocarbon, hydrofluorocarbon, hydrochlorofluorocarbon, fluorocarbon, hydrochlorofluoroolefin (HCFO), hydrofluoroolefin (HFO), dialkyl ether or a fluorine-substituted dialkyl ether, or a mixture of two or more thereof. Blowing agents of these types include propane, isopentane, n-pentane, n-butane, isobutane, isobutene, cyclopentane, dimethyl ether, 1,1-dichloro-1-fluoroethane (HCFC-141b), chlorodifluoromethane (HCFC-22), 1-chloro-1,1-difluoroethane (HCFC-142b), 1,1,1,2-tetrafluoroethane (HFC-134a), 1,1,1,3,3-pentafluorobutane (HFC-365mfc), 1,1-difluoroethane (HFC-152a), 1,1,1,2,3,3,3-heptafluoropropane (HFC-227ea) and 1,1,1,3,3-pentafluoropropane (HFC-245fa). Examples of HFO and HFCO blowing agents include pentafluoropropenes, such as HFO-1225yez and HFO-1225ye; tetrafluoropropenes, such as HFO-1234yf and HFO-1234ez; 1,1,1,4,4,4-hexafluoro-2-butene (HFO-1336m/z); 1-chloro-3,3,3-trifluoropropene (HCFO-1233zd); 1,2-difluoro-3,3,3-trifluoropropene (HCFO-1223×d); 2-chloro-3,3,3-trifluoropropene (HCFO-1233xf). Such blowing agents are disclosed in numerous publications, for example, publications WO2008121785A1 WO2008121790A1; WO2011/135395; US 2008/0125506; US 2011/0031436; US2009/0099272; US2010/0105788; US2011/0210289 and 2011/0031436. The hydrocarbon and hydrofluorocarbon blowing agents are preferred. It is generally preferred to further include water in the formulation, in addition to the physical blowing agent.

Blowing agent(s) are preferably used in an amount sufficient such that the formulation cures to form a foam having a molded density of from 16 to 160 kg/m³, preferably from 16 to 64 kg/m³ and especially from 20 to 48 kg/m³. To achieve these densities, the hydrocarbon or hydrofluorocarbon blowing agent conveniently is used in an amount ranging from about 10 to about 40, preferably from about 12 to about 35, parts by weight per 100 parts by weight polyol(s). Water reacts with isocyanate groups to produce carbon dioxide, which acts as an expanding gas. Water is suitably used in an amount within the range of 0.5 to 3.5, preferably from 1.0 to 3.0 parts by weight per 100 parts by weight of polyol(s).

The polyurethane-forming composition typically will include at least one catalyst for the reaction of the polyol(s) and/or water with the polyisocyanate. Suitable urethane-forming catalysts include those described by U.S. Pat. No. 4,390,645 and in WO 02/079340, both incorporated herein by reference. Representative catalysts include tertiary amine and phosphine compounds, chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt.

Tertiary amine catalysts are generally preferred. Among the tertiary amine catalysts are dimethylbenzylamine (such as Desmorapid® DB from Rhine Chemie), 1,8-diaza(5,4,0)undecane-7 (such as Polycat® SA-1 from Air Products), pentamethyldiethylenetriamine (such as Polycat® 5 from Air Products), dimethylcyclohexylamine (such as Polycat® 8 from Air Products), triethylene diamine (such as Dabco® 33LV from Air Products), dimethyl ethyl amine, n-ethyl morpholine, N-alkyl dimethylamine compounds such as N-ethyl N,N-dimethyl amine and N-cetyl N,N-dimethylamine, N-alkyl morpholine compounds such as N-ethyl morpholine and N-coco morpholine, and the like. Other tertiary amine catalysts that are useful include those sold by Air Products under the trade names Dabco® NE1060, Dabco® NE1070, Dabco® NE500, Dabco® TMR-2, Dabco® TMR-4, Dabco® TMR 30, Polycat® 1058, Polycat® 11, Polycat 15, Polycat® 33 Polycat® 41 and Dabco® MD45, and those sold by Huntsman under the trade names ZR 50 and ZR 70. In addition, certain amine-initiated polyols can be used herein as catalyst materials, including those described in WO 01/58976 A. Mixtures of two or more of the foregoing can be used.

The catalyst is used in catalytically sufficient amounts. For the preferred tertiary amine catalysts, a suitable amount of the catalysts is from about 0.3 to about 2 parts, especially from about 0.3 to about 1.5 parts, of tertiary amine catalyst(s) per 100 parts by weight of the polyol(s).

The polyurethane-forming composition also preferably contains at least one surfactant, which helps to stabilize the cells of the composition as gas evolves to form bubbles and expand the foam. Examples of suitable surfactants include alkali metal and amine salts of fatty acids such as sodium oleate, sodium stearate sodium ricinolates, diethanolamine oleate, diethanolamine stearate, diethanolamine ricinoleate, and the like: alkali metal and amine salts of sulfonic acids such as dodecylbenzenesulfonic acid and dinaphthylmethanedisulfonic acid; ricinoleic acid; siloxane-oxalkylene polymers or copolymers and other organopolysiloxanes; oxyethylated alkylphenols (such as Tergitol NP9 and Triton X100, from The Dow Chemical Company); oxyethylated fatty alcohols such as Tergitol 15-S-9, from The Dow Chemical Company; paraffin oils; castor oil; ricinoleic acid esters; turkey red oil; peanut oil; paraffins; fatty alcohols; dimethyl polysiloxanes and oligomeric acrylates with polyoxyalkylene and fluoroalkane side groups. These surfactants are generally used in amount of 0.01 to 6 parts by weight based on 100 parts by weight of the polyol.

Organosilicone surfactants are generally preferred types. A wide variety of these organosilicone surfactants are commercially available, including those sold by Goldschmidt under the Tegostab® name (such as Tegostab B-8462, B8427, B8433 and B-8404 surfactants), those sold by OSi Specialties under the Niax® name (such as Niax® L6900 and L6988 surfactants) as well as various surfactant products commercially available from Air Products and Chemicals, such as DC-193, DC-198, DC-5000, DC-5043 and DC-5098 surfactants.

In addition to the foregoing ingredients, the polyurethane-forming composition may include various auxiliary components such as fillers, colorants, odor masks, flame retardants, biocides, antioxidants, UV stabilizers, antistatic agents, viscosity modifiers and the like.

Examples of suitable flame retardants include phosphorus compounds, halogen-containing compounds and melamine.

Examples of fillers and pigments include calcium carbonate, titanium dioxide, iron oxide, chromium oxide, azo/diazo dyes, phthalocyanines, dioxazines, recycled rigid polyurethane foam and carbon black.

Examples of UV stabilizers include hydroxybenzotriazoles, zinc dibutyl thiocarbamate, 2,6-ditertiarybutyl catechol, hydroxybenzophenones, hindered amines and phosphites.

Except for fillers, the foregoing additives are generally used in small amounts. Each may constitute from 0.01 percent to 3 percent of the total weight of the polyurethane formulation. Fillers may be used in quantities as high as 50% of the total weight of the polyurethane formulation.

The polyurethane-forming composition is prepared by bringing the various components together under conditions such that the polyol(s) and isocyanate(s) react, the blowing agent generates a gas, and the composition expands and cures. All components (or any sub-combination thereof) except the polyisocyanate can be pre-blended into a formulated polyol composition if desired, which is then mixed with the polyisocyanate when the foam is to be prepared. The components may be preheated if desired, but this is usually not necessary, and the components can be brought together at about room temperature (˜22° C.) to conduct the reaction. It is usually not necessary to apply heat to the composition to drive the cure, but this may be done if desired, too.

The invention is particularly useful in production of sandwich composite elements which include at least two outer layers of a rigid or flexible material and a core layer of a rigid foam.

For the outer layers or facings it is in principle possible to use any of the conventionally used flexible or rigid facings, such as aluminum (lacquered and/or anodized), steel (galvanized and/or lacquered), copper, stainless steel, and non-metals, such a non-woven organic fibers, plastic sheets (e.g. polystyrene), plastic foils (e.g. PE foil), timber sheets, glass fibers, impregnated cardboard, paper, or mixtures of laminates of these. In generally preferable to use metallic facings, particularly made of aluminum and/or steel. The thickness of the facings is generally from 200 μm to 5 mm. In further embodiments, the thickness is greater than 300 μm or greater than 400 μm. In further embodiments, the thickness is less than 3 mm or less than 2 mm. An example of commercially available facings is Galvalumne™ metal facings.

Production of such composite elements may be made by processes known in the art. For example, after mixing of the components, the still liquid reaction mixture may be injected into an empty preassembled panel, which is contained within a press/fixture. These preassembled panels typically consist of the two facings, a surrounding rail which is typically made of wood, metal or a high density polyurethane, and locking devices used to connect the finished foamed panels together. After the foam has cured, the panel is removed from the press or the fixture.

Generally the foam layer will generally be from 2 cm to 25 cm in thickness. In other embodiments foam layer is from 2.5 to 21 cm and in a particular embodiment from 6 to 16 cm. The mold will generally be heated at a temperature in the range of 25° C. to 50° C. In particular, it was found formulations containing the present polyester shows good adhesion with a reduction is surface defects even the mold temperature drops below 35° C.

Applications for composite elements with rigid outer layers include use as truck bodies, hall doors and gates as well as in container construction. Insulating boards, composite elements with flexible outer layers, are employed as insulating materials in roofs, external walls and as floorboards.

It should be understood that the present description is for illustrative purposes only and should not be construed to limit the scope of the present invention in any way. Thus, those skilled in art will appreciate that various modifications and alterations to the presently disclosed embodiments might be made without departing from the intended spirit and scope of the present invention. Additional advantages and details of the present invention are evident upon an examination of the following examples and appended claims.

The following examples are provided to illustrate embodiments of the invention, but are not intended to limit the scope thereof. All parts and percentages are by weight unless otherwise indicated.

A description of the raw materials used in the examples is as follows.

DABCO DC 193 is a silicon surfactant available from Air Products (DABCO is a trademark of Air Products).

TERATE®-2031 polyol is a polyester polyol based on dimethyl terephthalate available from Invista.

Polyester A is a polyester polyol based on terephthalic acid, diethylene glycol, glycerin, and polyethylene glycol 200 as described herein.

VORANOL™ RH 490 is a sucrose/glycerin initiated polyoxypropylene polyol having a functionality of about 4.3 and a hydroxyl number of about 490 available from The Dow Chemical Company under the tradename Voranol RH 490.

POLYCAT® 8 is a N,N-dimethylcyclohexyl amine catalyst, available from Air Products.

TCPP, Tris(chloroisopropyl)phosphate, is a low viscous and low acidic flame retardant additive available from Supresta.

HFC-245fa, 1,1,1,3,3-pentafluoropropane, is a blowing agent available under the trade name Enovate® from Honeywell.

PAPI™ 27 polymeric MDI is a polymethylene polyphenylisocyanate that contains MDI available from The Dow Chemical Company.

The properties of the polyester polyols and formulations incorporating such polyesters are given in Tables 1 and 2 respectively.

TABLE 1
Polyester Polyol Properties.

| Raw Material Composition (wt %) | Terate 2031^{a} | Polyester A |
|---|---|---|
| TPA | | 39.6 |
| Glycerin | | 10.7 |
| DEG | | 9 |
| PEG 200 | | 40.7 |
| OH | 310 | 275 |
| Viscosity @25° C. (cP) | 12,000 | 16,000 |
| <fn> | 2.3 | 2.7 |

^{a}Commercial polyol commonly used to make flame retardant polyurethane foams, exact composition is unknown.

TABLE 2
Formulations.

| Components | C1 | Ex. #1 |
|---|---|---|
| Terate-2031 (DMT) | 17.08 | |
| Polyester A | | 17.08 |
| Voranol 490 | 17.07 | 17.07 |
| Water | 1.0 | 1.0 |
| Polycat 8 | 0.35 | 0.35 |
| TCPP | 5.00 | 5.00 |
| DC-193 | 0.75 | 0.75 |
| HFC-245fa | 6.00 | 6.00 |
| Total | 47.25 | 47.25 |
| Papi-27 | 52.75 | 52.75 |
| Total | 100.0 | 100.0 |

The properties of the produced polyurethanes foams are given in Table 3.

TABLE 3
Results.

| Properties | C1 | Ex. #1 |
|---|---|---|
| Mean (Gel Time (seconds)) | 71 | 70 |
| Mean (% Skin Intact @ 100° F.) | 47.6 | 98.7 |
| Mean (% Skin Intact @ 90° F.) | 15.9 | 79.8 |
| Mean (Green Strength @ 45 min) | 872 | 826 |
| lbs-force (Newtons) | (3883.9) | (3677.4) |
| Mean (Green Strength @ 30 min) | 689 | 708 |
| Mean (Compressive Strength) psi | 14.0 | 15.1 |
| (kPa) | (96.53) | (104.11) |
| Mean (Dimensional Stability | 4.3 | 3.5 |
| 158° F./97% RH - 14 day) | | |

Properties of the produced rigid polyurethane foams are measured using the following procedures. For the percent of skin intact, the respective formulations are poured into an aluminum mold (30×20×5 cm) which has been treated with a mold release agent and is heated at the indicated temperature. After 30 minutes, the mold is open and the amount of skin, which is attached to the two opposing surfaces of the mold, is measured. The amount of adherence to the mold gives an indication of the friability of the foam, that is, the greater the amount which adheres to the mold, the more brittle is the surface.

The compressive strength, in psi units, is measured according to ASTM D-1621 on foams produced at mold temperature of 37.8° C. (100° F.), demold after 30 minutes, and which are cured for at least 24 hours before testing. The dimensional stability represent the % volume changed after exposing the foam to 158° F. (70° C.), 97% relative humidity (RH) for 14 days. The dimensional stability is measured on foams produced in a mold heated to 37.8° C. (100° F.).

For green strength testing, a free rise sample is hand mixed and poured into an 8 inch (30.3 cm) long by 8 inch (20.3 cm) wide by 9.5 inch (24.1 cm) high wood mold (room temperature). Sufficient material is mixed to produce a foam so that the finished sample rises sufficiently to form a flat surface on the sides of at least 8 inches (20.3 cm) high. The foam is allowed to cure in the mold until 1 minute before the desired testing time, ie 29 minutes for a 30-minute test result.

The green strength test procedure is conducted on an Instron 5566 Extra wide Materials Testing System. The load cell (UK 537/2000 lb) is mounted in a crosshead which rides in the vertical guides of the load frame. The test specimen is placed on a test platen and is then compressed by an indenter foot 8 inches (20.3 cm) in diameter which is affixed to the load cell.

To begin the green strength test, the foam sample is positioned horizontally (compared to the pour) and centered on the Instron test platen. At 15 seconds prior to the desired time [29 min. 45 sec. after removal from the mold for a 30-minute test], the test is started. This initiates the Instron to lower the crosshead from the beginning 228.6 mm (9 inch (22.9 cm)) height position at a rate of 100 mm/min until the load cell makes contact with the foam sample. The crosshead continues to lower until a force of 8.9 N (2.0 lbf) is reached, at which time the thickness is automatically recorded. Next, the crosshead lowers again; this time at a rate of 305 mm/min until a 25.4 mm compression is obtained (compared to the 2.0 lbf thickness) at which time the maximum compression load (Green Strength) is automatically recorded. Green strength values give an indication of a molded or cast products ability to withstand handling, mold ejection, and machining before it is completely cured or hardened.

The foams produced using the formulations in Table 3 indicated that the rigid foams produced using the formulation of Example #1 show significant improvement for % skin cure@90° F. and 100° F. relative to the control (C1). The intact skin properties are achieved while maintaining or slightly improving the other properties of the foam.

While the foregoing is directed to embodiments of the invention, other and further embodiments of the invention may be devised without departing from the basic scope thereof.

1. An aromatic polyester polyol comprising the reaction product of at least:
A) an aromatic component comprising 80 mole percent or greater of terephthalic acid;
B) at least one polyether polyol having a nominal functionality of 2, a molecular weight of 150 to 1000 and has a polyoxyethylene content of at least 70% by weight of the polyol; and
C) at least one glycol other than B having a molecular weight from 60 to 250; D) at least one glycol having a molecular weight of 60 to 250 and a nominal functional of at least 3;
wherein A, B, C and D are present in the reaction on a percent weight bases of 20 to 60 weight percent A); 20 to 60 weight percent of B) and 5 to 20 weight percent of C) and 5 to 20 weight percent of D).

2. A polyol mixture for production of a rigid foam comprising:
a first polyol which is polyester polyol comprising the reaction product of at least:
A) an aromatic component comprising 80 mole percent or greater of terephthalic acid;
B) at least one polyether polyol having a nominal functionality of 2, a molecular weight of 150 to 1000 and has a polyoxyethylene content of at least 70% by weight of the polyol; and
C) at least one glycol other than B having a molecular weight from 60 to 250; D) at least one glycol having a molecular weight of 60 to 250 and a nominal functional of at least 3;
wherein A, B, C and D are present in the reaction on a percent weight bases of 20 to 60 weight percent A); 20 to 60 weight percent of B) and 5 to 20 weight percent of C) and 5 to 20 weight percent of D) and
2) a second polyol which is a polyether polyol having a functionality of 2 to 8 and a molecular weight of 100 to 2,000; wherein the first to second polyol are present in a weight percent of the polyol mixture from 20 to 90 weight percent of the first polyol and 10 to 80 weight percent of the second polyol.

3. A composite element comprising:
i) a lower facing,
ii) a rigid foam product comprising the reaction product of
(1) an isocyanate and
(2) a poyol mixture wherein the polyol mixture comprises
a first polyol which is polyester polyol comprising the reaction product of:
at least
A) an aromatic component comprising 80 mole percent or greater of terephthalic acid;
B) at least one polyether polyol having a nominal functionality of 2, a molecular weight of 150 to 1000 and has a polyoxyethylene content of at least 70% by weight of the polyol; and
C) at least one glycol other than B having a molecular weight from 60 to 250;
D) at least one glycol having a molecular weight of 60 to 250 and a nominal functional of at least 3;
wherein A, B, C and D are present in the reaction on a percent weight bases of 20 to 60 weight percent A); 20 to 60 weight percent of B) and 5 to 20 weight percent of C) and 5 to 20 weight percent of D).
and
a second polyol which is a polyether polyol having a functionality of 2 to 8 and a molecular weight of 100 to 2,000; wherein the first to second polyol are present in a weight percent of the polyol mixture from 20 to 90 eight percent of the first polyol and 10 to 80 weight percent of the second polyol and
iii) an upper facing.

4. The composite element of claim 3 wherein B) has a number average molecular weight of less than 500.

5. The composite element of claim 4 wherein the aromatic component and the polyethylene glycol are each added to the polyester polyol in an amount from 35 to 45 weight percent.

6. The composite element of claim 5 wherein the isocyanate index is from 80 to 200. preferentially 100 to 150.

7. The composite element of claim 6 wherein the rigid foam has a density of from 16 to 64 kg/m³.

8. A process for preparing a composite element according to claim 3 wherein the rigid foam (ii) which adhere to (i) and (iii) are prepared between (i) and (iii) by reacting the isocyanate and polyol mixture at temperature of 25° C. to 50° C.
